(19) United States
(12) Patent Application Publication
(10) Pub. No.: US 2011/0096791 A1
(43) Pub. Date: Apr. 28, 2011

(54) DATA COMMUNICATION SYSTEM AND DATA COMMUNICATION METHOD

(76) Inventor: TAKAHITO YAMAMOTO, Yamanashi (JP)

(21) Appl. No.: 12/908,104

(22) Filed: Oct. 20, 2010

(30) Foreign Application Priority Data
Oct. 23, 2009 (JP) 244617/2009

(51) Int. Cl. H04L 12/56

(52) U.S. Cl. 370/419

(57) ABSTRACT

A data communication system includes a data transmitting device and a data receiving device connected with the data transmitting device through a packet-switched network.

The data transmitting device includes a data packet generating unit which generates a plurality of data packets according to data transfer commands, a data packet transmitting unit which sends a plurality of data packets to the data receiving device, and a judging unit which judges completion of data transmission from the data transmitting device to the data receiving device.

The data receiving device includes a reply information issuing unit which issues a reply information at completion of each reception of a plurality of data packets, a reply information managing unit which counts number of the reply information that is issued by the reply information issuing unit and holds the count value, a reply packet generating unit which generates the reply packet including the count value of the concerned reply information by receiving the reply information from the reply information managing unit, and a reply packet transmitting unit which sends the reply packet generated by the reply packet generating unit to the data transmitting device.

The judging unit judges completion of the data transmission from the data transmitting device to the data receiving device based on number of data packets generated by the data packet generating unit and the count value included in the reply packet received from the data receiving device.

This application is based upon and claims the benefit of priority from Japanese Patent Application No. 2009-244617, filed on Oct. 23, 2009, the disclosure of which is incorporated herein in its entirety by reference.

### TECHNICAL FIELD

The present invention relates to a data communication system and a data communication method.

### BACKGROUND ART

A data transfer equipment having a transmitting device and a receiving device is disclosed in the Japanese Patent Application Laid-Open No. 1998-308932.

In the concerned data transfer equipment, a plurality of transmitting packets is treated as a block and the receiving device generates an acknowledgement response on each block unit and sends the response on each block unit to the transmitting device.

The receiving device generates and sends an acknowledgement response including ACK signal on each block unit to the transmitting device when all transmitted packets belonging to one block were received accurately. Alternatively, it generates and sends an acknowledgement response including a NAK signal on each block unit to the transmitting device when any of the transmitted packets belonging to one block were not received accurately.

When a NAK signal is contained in an acknowledgement response from the receiving device, the plural transmission packets to which retransmission is requested are copied and they are transmitted again through the transmitting device.

The receiving device includes a packet number in block storing means, an acknowledgement response generating means, and an acknowledgement response transmitting means.

In order to request to resend a packet to the transmitting device when the packet has errors or losses, the packet number in block storing means saves packet numbers in the block of the received packets until the acknowledgement response is generated.

When it completes receiving one block, the acknowledgement response transmitting means generates an acknowledgement response on the block, and the acknowledgement response transmitting means sends the acknowledgement response to the transmitting device.

In the data transfer equipment which is disclosed in the above-mentioned Japanese Patent Application Laid-Open No. 1998-308932, when it completes receiving transmitted packets of a block, the receiving device sends the acknowledgement response on the block to the transmitting device.

Here, in the concerned data transfer equipment, the order in which a plurality of packets in a block arrives at the receiving device is guaranteed, and the receiving device generates an acknowledgement response on the block and sends it to the transmitting device at a time when it received the last transmitted packet in the block.

In the data transfer equipment which is disclosed in the above-mentioned Japanese Patent Application Laid-Open No. 1998-308932, when the order in which a plurality of transmitting packets in the block arrives at the receiving device were misaligned by any causes and the last transmitted packet from the transmitting device has arrived at the receiving device earlier than other transmitted packets, the receiving device generates an acknowledgement response (i.e. the acknowledgement response that includes NAK signal in this case) at the time when the last transmitted packet was received.

Accordingly, in this case, there is a problem that the receiving device cannot send a correct acknowledgement response to the transmitting device.

### SUMMARY

An exemplary object of the present invention is to provide a data communication system and a data communication method capable of judging correctly completion of data transfer from a data transmitting device to a data receiving device even when receiving orders of data packets from the data transmitting device to the data receiving device are misaligned.

According to an exemplary aspect of the present invention, the data communication system includes the data transmitting device and the data receiving device connected with the data transmitting device through a packet-switched network.

The data transmitting device includes a data packet generating unit which generates a plurality of data packets according to data transfer commands, a data packet transmitting unit which sends a plurality of data packets to the data receiving device, and a judging unit which judges completion of the data transmission from the data transmitting device to the data receiving device.

The data receiving device includes a reply information issuing unit which issues a reply information at completion of each reception of plurality of data packet, a reply information managing unit which counts number of the reply information issued by the reply information issuing unit and holds the count value, a reply packet generating unit which generates a reply packet including the count value of the concerned reply information by receiving the reply information from the reply information managing unit, and a reply packet transmitting unit which sends the reply packet generated by the reply packet generating unit to the data transmitting device.

The judging unit judges completion of the data transmission from the data transmitting device to the data receiving device based on number of plurality of data packets which the data packet generating unit generated, and the count value included in the reply packet received from the data receiving device.

According to another exemplary aspect of the present invention, data communication method between the data transmitting device and the data receiving device, includes:
(A) generating a plurality of data packets according to a data transfer command in the data transmitting device;
(B) sending a plurality of data packets generated by (A) to the data receiving device;
(C) judging completion of data transmission from the data transmitting device to the data receiving device;
(D) issuing a reply information at completion of each reception of a plurality of data packets in the data receiving device;
(E) counting number of the reply information issued in (D) and holds the count value;
(F) generating a reply packet including the count value of the concerned reply information by receiving the reply information held in (E);
(G) sending the reply packet generated in (F) to the data transmitting device; and
(H) receiving the reply packet transmitted in (G) at the data transmitting device,

wherein (C) is based on number of plurality of data packets generated in (A) and the count value included in the reply packet received in (H).

### BRIEF DESCRIPTION OF THE DRAWINGS

Exemplary features and advantages of the present invention will become apparent from the following detailed descriptions when taken with the accompanying drawings in which:

FIG. 1 is a block diagram showing an entire configuration of a data communication system according to an exemplary embodiment.

FIG. 2 is a block diagram showing an exemplary configuration of a transmission side between nodes controlling unit.

FIG. 3 is a block diagram showing an exemplary configuration of a reception side between nodes controlling unit.

FIG. 4 is a block diagram showing an exemplary configuration of a reply controlling unit.

FIG. 5 is a flowchart showing a flow of the process in the reply controlling unit.

### EXEMPLARY EMBODIMENT

Hereinafter, exemplary embodiments will be described in detail using the drawings.

Further, it is supposed that an element with identical code in different drawings indicates that the element is identical or corresponding.

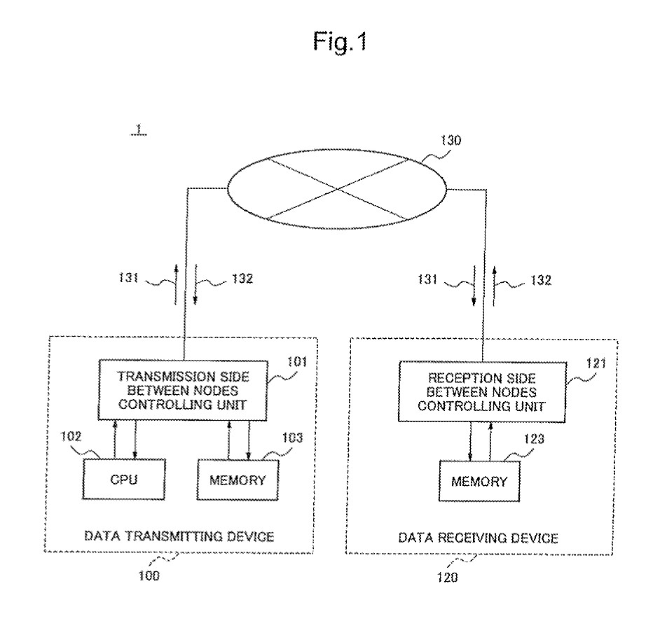

FIG. 1 is a block diagram showing an entire configuration of the data communication system 1 according to an exemplary embodiment.

A multiple node system is configured by connecting through a communication network between nodes 130 (i.e. packet-switched network) a data transmitting device 100 and a data receiving device 120 that are communication nodes.

The data transmitting device 100 includes a transmission side between nodes controlling unit 101, a CPU 102, and a memory 103.

The transmission side between nodes controlling unit 101 accepts a startup command for the transmission between the nodes from the CPU 102, decomposes a transfer volume between the nodes per one command to multiple packets for the transmission, reads out the transfer data from the memory 103, generates data packets 131, and executes the transmission between the nodes.

The data receiving device 120 includes a reception side between nodes controlling unit 121 and a memory 123.

After receiving the data packet 131 sent through a communication network between nodes 130 from the data transmitting device 100 and storing the data in the memory 123, the reception side between nodes controlling unit 121 returns a reply packet 132 to the data transmitting device 100 which is a transmission source node.

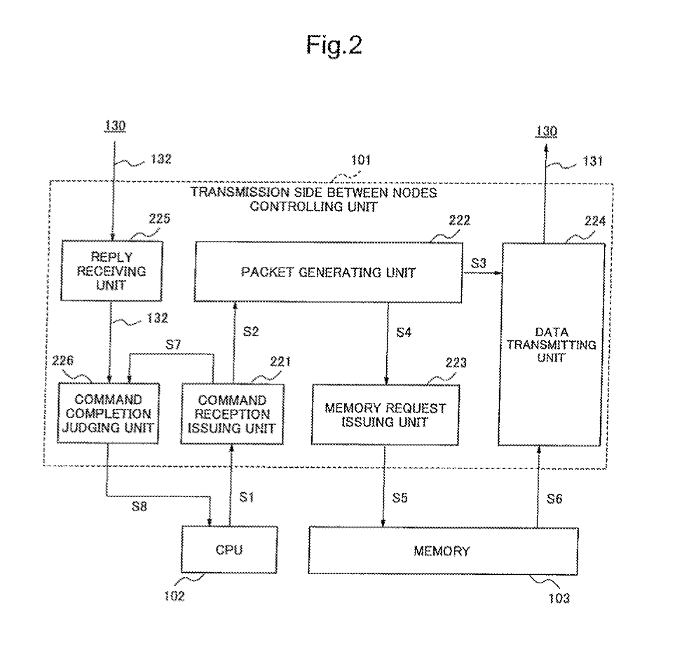

FIG. 2 is a block diagram showing an exemplary configuration of the transmission side between nodes controlling unit 101.

As shown in FIG. 2, the transmission side between nodes controlling unit 101 includes and constitutes a command reception issuing unit 221, a packet generating unit 222, a memory request issuing unit 223, a data transmitting unit 224, a reply receiving unit 225, and a command completion judging unit 226.

The command reception issuing unit 221 receives a transmission between nodes startup command S1 from the CPU 102, adds an identification information (hereinafter, referred to as “RID”) on each transmission between nodes startup command S1, and executes issuing a command S2.

The packet generating unit 222 decomposes the issued command S2 according to the packet size for the data transfer between the nodes. That is, the packet generating unit 222 generates header information S3 for transmitting plural packets of the decomposed size to the data transmitting unit 224. The packet generating unit 222 also generates and inputs the requests S4 requesting the data S6 from the memory 103 for the plural packets in a unit of decomposed packet to the memory request issuing unit 223.

After receiving a request S4 on each packet unit from the packet generating unit 222, the memory request issuing unit 223 issues a read-out request S5 for reading out data S6 from the memory 103.

The data transmitting unit 224 assembles the data S6 read out from the memory 103 for each packet size and completes alignment of the data. The data transmitting unit 224 sends the data packet 131 as well as the header information S3 sent from the packet generating unit 222 to the communication network between nodes 130.

The reply receiving unit 225 and the command completion judging unit 226 function as a waiting means for executing the end judgment process of a command (i.e. judgment of completion of the data transmission from the data transmitting device 100 to the data receiving device 120).

The reply receiving unit 225 receives the reply packet 132 sent from the data receiving device 120 through the communication network between nodes 130.

The reply packet 132 is inputted from the reply receiving unit 225 to the command completion judging unit 226.

When the command S2 is issued by the command reception issuing unit 221, information S7 on RID and number of packet decomposition are inputted from the command reception issuing unit 221 to the command completion judging unit 226.

The command completion judging unit 226 judges the command completion based on the reply packet 132 and the information S7.

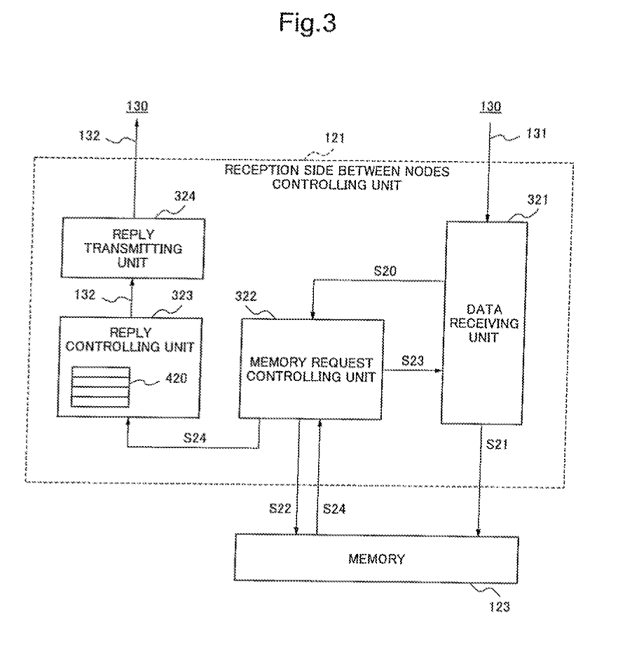

FIG. 3 is a block diagram showing an exemplary configuration of the reception side between nodes controlling unit 121.

As shown in FIG. 3, the reception side between nodes controlling unit 121 includes a data receiving unit 321, a memory request controlling unit 322, a reply controlling unit 323, and a reply transmitting unit 324.

The data receiving unit 321 receives the data packet 131 from the communication network between nodes 130, sends a header information S20 (corresponds to the header information S3 in FIG. 2) of the received data packet 131 to the memory request controlling unit 322, and holds data S21 of the packet.

The memory request controlling unit 322 generates a memory request S22 for storing the data S21 of the packet in the memory 123 from the header information S20 sent from the data receiving unit 321, and inputs a data read-out order S23 for reading the data S21 from the receiving unit 321 at the time of storing to the memory.

The reply controlling unit 323 identifies the group of the data packet 131 based on the node number for identifying the transmission source node and RID added to the command unit at the data transmitting device 100 that is a transmission source node, and generates the reply packet 132 by assembling the reply information.

The reply transmitting unit 324 sends the reply packet 132 generated in the reply controlling unit 323 to the data transmitting device 100 through the communication network between nodes 130.

The memory request controlling unit 322 receives a reply information S24 from the memory 123 after the data S21 is stored in the memory 123, and sends the reply information S24 including the node number and RID to the reply controlling unit 323.

The reply controlling unit 323 holds a reply management table 420, and executes a process of assembling the reply information S24 using the reply management table 420.

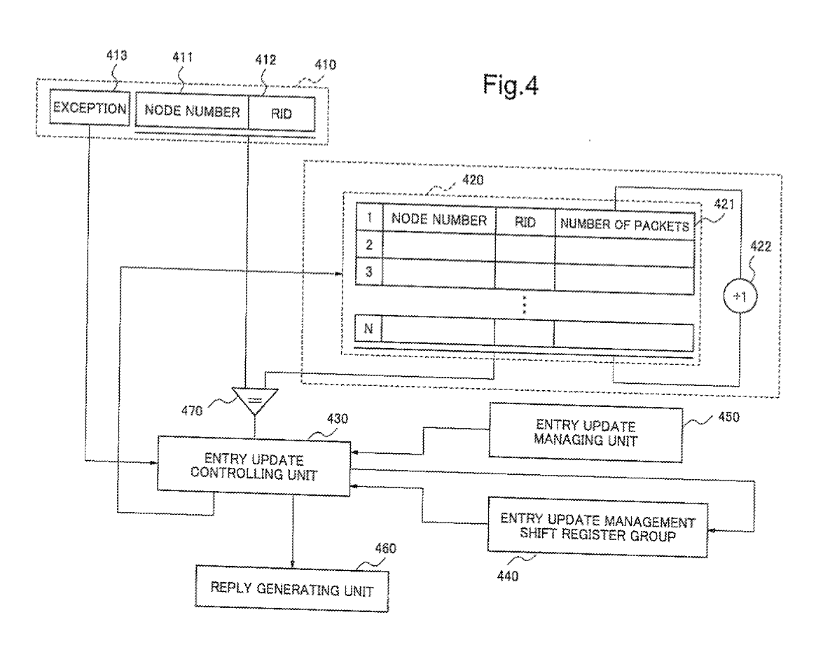

FIG. 4 is a block diagram showing an exemplary configuration of the reply controlling unit 323.

As shows in FIG. 4, the reply controlling unit 323 includes a reply management table 420, an entry update controlling unit 430, an entry update management shift register group 440, an entry update managing unit 450, a reply generating unit 460, a comparator 470, and an adder 422.

The reply management table 420 has a plurality of entry frames 421 (hereinafter, referred to as “entry”) for storing a reply information 410 (corresponds to the reply information S24 of FIG. 3) sent from the memory request controlling unit 322.

The entry update controlling unit 430 searches the reply management table 420 and updates an entry 421 which is an update object.

The entry update management shift register group 440 manages an oldest entry 421 by registration order of the entry.

When an entry release condition is not met, the entry update managing unit 450 executes a compulsory release.

The reply generating unit 460 generates the reply packet 132 based on the reply information 410 stored in the reply management table 420.

The comparator 470 compares a node number 411 and RID 412 included in the reply information 410 sent from the memory request controlling unit 322, and the node number and RID of each entry 421 in the reply management table 420.

As a result of the comparison by the comparator 470, the adder 422 adds “1” to number of packets in the corresponding entry 421 when they are matched.

Hereinafter, the operation of the data communication system 1 will be described according to the exemplary embodiment.

First, a fundamental operation of the data transfer will be described.

As shown in FIG. 2, when the CPU 102 issues the transmission between nodes startup command S1, the command reception issuing unit 221 accepts the startup command, adds unique RID on each accepted command, and issues the command S2 to the packet generating unit 222.

At the same time, the command reception issuing unit 221 sends information S7 concerning RID and number of packet decomposition necessary to judge the command completion to the command completion judging unit 226.

The packet generating unit 222 decomposes the issued command S2 according to the packet size for the data transfer between nodes. The packet generating unit 222 generates header information S3 for transmitting plural data packets 131 of the decomposed size in a unit of decomposed packet.

The command S2 includes total data size and transmission start address at both of the transmission side and the receiving side of the total size data, for example. The packet generating unit 222 calculates transmission start address at both of the transmission side and the receiving side of each decomposed size data based on the packet size for the data transfer between nodes, and generates the header information S3 including them and the decomposed data size for each data packet 131.

The packet generating unit 222 also generates and inputs the requests S4 in a unit of decomposed packet to the memory request issuing unit 223.

The packet generating unit 222 sends the header information S3 to the data transmitting unit 224. The memory request issuing unit 223 issues the read-out request S5 of the packet unit based on the request S4 from the packet generating unit 222, reads out the data S6 from the memory 103 and sends the data S6 read out from the memory 103 to the data transmitting unit 224.

The data transmitting unit 224 assembles the data S6 inputted from the memory 103 for each packet size, and when the data alignment completed, by combining the header information S3 sent from the packet generating unit 222 in advance, generates the data packet 131.

After that, the data transmitting unit 224 sends the data packet 131 to the communication network between nodes 130.

The data packet 131 from the data transmitting unit 224 is transferred to the data receiving device 120, which is a destination node, through the communication network between nodes 130.

By the control of the reception side between nodes controlling unit 121, the data receiving device 120 stores the data in the memory 123.

As shown in FIG. 3, the data receiving unit 321 receives the data packet 131 from the communication network between nodes 130, extracts the header information S20 from the received data packet 131, sends it to the memory request controlling unit 322, and holds the data S21 of the data packet 131.

The memory request controlling unit 322 generates the memory request S22 for storing the data to the memory 123 and inputs to the memory 123 based on the header information S20 in the packet sent from the data receiving unit 321, and also stores the data S21 in the memory 123 by inputting the data read-out order S23 to the data receiving unit 321.

When receiving the reply information S24 from the memory 123 after the data S21 is stored to the memory 123, the memory request controlling unit 322 sends the reply information S24 including the node number and RID to the reply controlling unit 323.

The reply controlling unit 323 has the reply management table 420 and by executing the process of identifying the group of the data packet 131 based on the node number and RID and assembling the reply information S24, generates the reply packet 132 which a plurality of reply information S24 is assembled.

The reply transmitting unit 324 sends the reply packet 132 generated in the reply controlling unit 323 to the data transmitting device 100 through the communication network between nodes 130.

As shown in FIG. 2, the reply receiving unit 225 accepts the reply packet 132 received from the communication network between nodes 130, and sends the reply packet 132 to the command completion judging unit 226

The command completion judging unit 226 judges the command completion based on count value of the reply information included in the reply packet 132 and information S7 about RID and number of packet decomposition inputted from the command reception issuing unit 221 in advance.

Specifically, when the count value (accumulated total count value when it is divided into a plurality of reply packets 132) of the reply information included in the reply packet 132 equals to the number of packet decomposition, the command completion judging unit 226 judges that the command has completed and sends a final report S8 to the CPU 102 that is the command source.

As a result, the data transfer corresponding to a command has completed.

Next, an operation of the reply controlling unit 323 will be described.

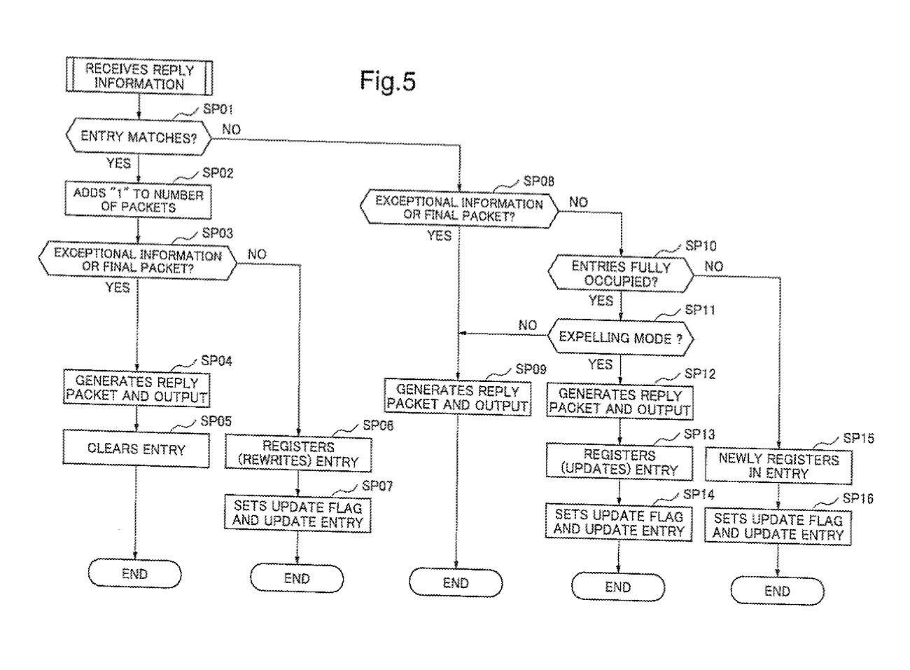

FIG. 5 is a flowchart showing a process flow in the reply controlling unit 323.

A process of the reply controlling unit 323 is initiated when the reply controlling unit 323 receives the reply information 410 from the memory request controlling unit 322 by storing the data packet 131 transmitted from the communication network between nodes 130 in the memory 123.

As shown in FIG. 4, the reply information 410 includes the node number 411 and RID 412.

The reply controlling unit 323 identifies a group of the data packet 131 by the node number 411 and RID 412.

Further, when the boundary violation or the like of the memory access has happened, the reply information 410 includes an exceptional information 413.

When the reply controlling unit 323 receives the reply information 410, by searching the reply management table 420 using the comparator 470, the entry update controlling unit 430 judges whether the entry 421 that matches with the node number 411 and the RID 412 of the received reply information 410 exists or not in the reply management table 420, in step SP01.

When the same entry 421 exists (in other words, when result of the judgment in step SP01 is “YES”), the entry update controlling unit 430 reads out the corresponding entry 421 from the reply management table 420, and updates number of packets by the adder 422, in step SP02.

In other words, it adds “1” to number of packets in the corresponding entry 421.

Next, in step SP03, the entry update controlling unit 430 judges whether the received reply information 410 includes the exceptional information 413 or the received reply information 410 is a final packet (last packet) in the group of the data packet 131.

In step SP03, if the received reply information 410 includes the exceptional information 413 or the received reply information 410 is a final packet (in other words, when result of the judgment in step SP03 is “YES”), re-register to the reply management table 420 is not executed and the reply generating unit 460 generates the reply packet 132, in step SP04.

Specifically, information about the node number, RID, and number of packets (number of packets after updated in step SP02) in the entry 421 read out from the reply management table 420 are inputted from the entry update controlling unit 430 to the reply generating unit 460.

And the reply generating unit 460 generates the reply packet 132 based on these information.

The reply transmitting unit 324 sends the generated reply packet 132 to the data transmitting device 100 through the communication network between nodes 130.

Next, the entry update controlling unit 430 clears content of the entry 421, whose reply packet 132 has generated, from the reply management table 420, in step SP05.

In step SP03, when the received reply information 410 does not include the exceptional information 4B and is not the final packets (in other words, when result of the judgment in step SP03 is “NO”), the entry update controlling unit 430 executes the registration (rewrites) of the entry 421 read out from the reply management table 420 to the reply management table 420, in step SP06.

Next, the entry update controlling unit 430 sets an update flag to “1” and sets the updated entry 421 to the latest entry in the entry update management shift register group 440, in step SP07.

In step SP01, when a matched entry 421 does not exist (in other words, when result of the judgment in step SP01 is “NO”), the entry update controlling unit 430 judges whether the received reply information 410 includes the exceptional information 413 or the received reply information 410 is a final packet, in step SP08.

In step SP08, when the received reply information 410 includes the exceptional information 413 or the received reply information 410 is a final packet (in other words, when result of the judgment in step SP08 is “YES”), the reply generating unit 460 generates the reply packet 132 based on the reply information 410, in step SP09.

The reply transmitting unit 324 sends the generated reply packet 132 to the data transmitting device 100 through the communication network between nodes 130.

In step SP08, when the received reply information 410 does not include the exceptional information 413 and is not the final packets (in other words, when result of the judgment in step SP08 is “NO”), the entry update controlling unit 430 judges whether all entries 421 of the reply management table 420 are fully occupied, in step SP10.

In other words, it judges whether the vacant entry exists in the reply management table 420 or not.

In step SP10, when a vacant entry exists (in other words, when result of the judgment in step SP10 is “NO”), the entry update controlling unit 430 newly registers the received reply information 410 in the vacant entry of the reply management table 420, in step SP15.

Next, the entry update controlling unit 430 sets the update flag to “1” and sets the newly registered entry 421 as the latest entry in the entry update management shift register group 440, in step SP16.

In step SP10, when a vacant entry does not exist (in other words when result of the judgment in SP10 is “YES”), the entry update controlling unit 430 judges whether a mode is set to an expelling mode (i.e. expulsion mode) to drive the oldest entry out from the reply management table 420 in order to register a new entry, in step SP11.

In step SP11, when it is not set to the expelling mode (in other words, when result of the judgment in step SP11 is “NO”), the reply generating unit 460 generates the reply packet 132 based on the reply information 410, in step SP09.

The reply transmitting unit 324 sends the created reply packet 132 to the data transmitting device 100 through the communication network between nodes 130.

In step SP11, when it is set to the expelling mode (in other words, when result of the judgment in step SP11 is “YES”), the reply generating unit 460 generates the reply packet 132 concerning the entry 421 registered at the oldest time (including the initial registration and the update registration) in the reply management table 420, in step SP12.

In this case, the oldest entry is read out from the reply management table 420, and the information including node number, RID, and number of packets in the oldest entry are inputted from the entry update controlling unit 430 to the reply generating unit 460.

The reply transmitting unit 324 sends the created reply packet 132 to the data transmitting device 100 through the communication network between nodes 130.

Further, the entry number of each entry 421 of the reply management table 420 is registered in the entry update management shift register group 440, and an oldest entry is judged by shifting in registered order of each entry 421.

Thus, by expelling the oldest entry from the entry management table 420 and by returning the reply packet 132 to the data transmitting device 100, even when a final packet is arrived ahead of other packets due to packets loss or an occurrence of reverse of the packet order happens because of communication failures, it can be avoided that the reply packet 132 from the data receiving device 120 is not returned for a long time and stagnated.

Next, in step SP13, the entry update controlling unit 430 registers (updates) the received reply information 410 in the reply management table 420 for the oldest entry as the update object.

In other words, by expelling the oldest entry from the entry management table 420, a vacant entry is created and newly received reply information 410 is registered in the vacant entry.

Next, in step SP14, the entry update controlling unit 430 sets the update flag to “1” and sets the entry 421, which the registration is updated, as the latest entry in the entry update management shift register group 440.

As is stated above, the entry 421 of the reply management table 420 is released (released normally) from the reply management table 420 when the exceptional information 413 is included in the received reply information 410, the received reply information 410 is a final packet, or the received reply information 410 is to be registered at the time when the reply management table 420 is fully occupied.

Although it is not shown in the flowchart in FIG. 5, in the reply controlling unit 323, a compulsory release of the entry 421 by a control of the entry update managing unit 450 can be also executed besides the above-mentioned normal release.

The entry update managing unit 450 measures an elapsed time since the count value of number of packets is finally updated on each entry 421 of the entry management table 420.

Information on the elapsed time of each entry 421 is inputted from the entry update managing unit 450 to the entry update controlling unit 430.

The entry update controlling unit 430 reads out the entry that the elapsed time is exceeded beyond a prefixed time (in other words, the entry which is not updated during the latest prefixed interval) from the reply management table 420, and sends it to the reply generating unit 460.

The reply generating unit 460 generates the reply packet 132 of the concerned entry, and the reply transmitting unit 324 sends the generated reply packet 132 to the data transmitting device 100 through the communication network between nodes 130.

Thus, by executing the compulsory release when the elapsed time from the last time of update exceeds a prefixed time, even when a final packet is arrived ahead of other packets due to packets loss or an occurrence of reverse of the packet order happens because of communication failures, the situation that the reply packet 132 from the data receiving device 120 is not returned for a long time and stagnated can be avoided.

Thus, according to the data communication system 1 in the exemplary embodiment, each time that a reception of a plurality of data packets 131 is completed, the memory request controlling unit 322 (reply information issuing unit) issues the reply information S24 in the data receiving device 120.

The reply controlling unit 323 (reply information managing unit) holds the count value (number of packets) of the reply information S24 issued by the memory request controlling unit 322 using the reply management table 420.

Further, the reply generating unit 460 generates the reply packet 132 including the count value about the concerned reply information by receiving the reply information from the entry update controlling unit 430.

The reply transmitting unit 324 sends the reply packet 132 generated by the reply generating unit 460, to the data transmitting device 100.

In addition, in the data transmitting device 100, the command completion judging unit 226 judges the completion of the data transmission from the data transmitting device 100 to the data receiving device 120 based on the decomposed number of the data packet inputted from the command reception issuing unit 221, and the count value of the reply information included in the reply packet 132 received from the data receiving device 120.

Thus, the data receiving device 120, in stead of returning the reply packet 132 to the data transmitting device 100 on each of plural data packets 131, answers the reply packet 132 including information about number of packets of the received data packet 131.

Accordingly, because number of the reply packets 132 which flow on the communication network between nodes 130 can be reduced, communications traffic of the communication network between nodes 130 can be reduced.

As a result, because it can be avoided that the transmission of the data packet 131 will be obstructed by a huge amount of reply packets, it can achieve performance improvement of the data transfer between the nodes.

In addition, because the command completion judging unit 226 judges the command completion based on number of decomposition of the data packet and the count value of the reply information included in the reply packet 132, even when a final packet is arrived ahead of other packets due to packets loss or an occurrence of reverse of the packet order happens because of communication failures, the command completion judging unit 226 can correctly judges completion of the data transfer from the data transmitting device 100 to the data receiving device 120.

While the invention has been particularly shown and described with reference to exemplary embodiments thereof. The invention is not limited to these embodiments. It will be understood by those of ordinary skill in the art that various changes in form and details may be made therein without departing from the spirit and scope of the present invention as defined by the claims.

1. A data communication system comprising:
a data transmitting device; and
a data receiving device that is connected with said data transmitting device through a packet-switched network, wherein
said data transmitting device comprises:
a data packet generating unit which generates a plurality of data packets according to a data transfer command;
a data packet transmitting unit which sends said plurality of data packets to said data receiving device; and
a judging unit which judges completion of data transmission from said data transmitting device to said data receiving device, and
said data receiving device comprises:
a reply information issuing unit which issues a reply information at completion of each reception of a plurality of said data packets;
a reply information managing unit which counts number of the reply information that is issued by said reply information issuing unit and holds the count value;
a reply packet generating unit which generates a reply packet including the count value about the reply information by receiving the reply information from said reply information managing unit; and
a reply packet transmitting unit which sends the reply packet that is generated by said reply packet generating unit to said data transmitting device, wherein
said judging unit judges completion of data transmission from said data transmitting device to said data receiving device based on number of said plurality of data packets of which said data packet generating unit generates and the count value that is included in the reply packet that is received from said data receiving device.

2. The data communication system according to claim 1, wherein
said reply information managing unit comprising:
a management table which comprises a class of reply information that is classified by an identification information in a data transfer command and an identification information in said data transmitting device and entry frames with which the count value corresponding to the concerned reply information are registered; and
an order managing unit which manages registration order of the reply information to said management table, wherein
said reply information managing unit creates a vacant entry frame in said management table and registers the reply information of a new class in the vacant entry frame by sending the oldest registered reply information in said management table from said management table to said reply packet generating unit in a situation that the vacant entry frame does not exist in said management table and registers a new class of reply information in said management table at said reply information managing unit.

3. The data communication system according to claim 1, wherein
said reply information managing unit comprising:
a management table with which the reply information and a count value corresponding to the concerned reply information are registered; and
a time counting unit which measures an elapsed time after the count value corresponding to the reply information is finally updated in said management table, wherein
said reply information managing unit sends the concerned reply information from said management table to said reply packet generating unit when the elapsed time of the concerned reply information that is measured by said time counting unit exceeds a prefixed value.

4. A data communication method between said data transmitting device and said data receiving device comprising:
(A) generating a plurality of data packets according to data transfer command in said data transmitting device;
(B) sending said plurality of data packets that are generated by said (A) to said data receiving device;
(C) judging the completion of the data transmission from said data transmitting device to said data receiving device;
(D) issuing a reply information in said data receiving device at completion of each reception of said plurality of the data packets;
(E) counting number of the reply information that is issued in said (D) and holds the count value;
(F) generating a reply packet including the count value of the reply information by receiving the reply information held in said (E);
(G) sending the reply packet that is generated in said (F) to said data transmitting device; and
(H) receiving the reply packet that is transmitted by said (G) in said data transmitting device, wherein (C) is based on number of said plurality of data packets that is generated in said (A) and the count value that is included in the reply packet that is received in said (H).

5. The data communication method according to claim 4, wherein said (E) comprising:
(E-1) holding said count value using said management table which has a plurality of classes of reply information that is classified by an identification information in a data transfer command and an identification information in said data transmitting device, and entry frames with which the count value corresponding to the concerned reply information are registered; and
(E-2) managing the registration order of the reply information to said management table, wherein
a vacant entry frame in said management table is created and the reply information of a new class is registered in the vacant entry frame by generating a reply packet concerning the oldest registered reply information in said management table in a situation that the vacant entry frame does not exist in said management table and a the new class of reply information is registered in said management table.

6. The data communication method according to claim 4, wherein
said (E) comprising:
(E-1) holding said count value using said management table with which the reply information and the count value corresponding to concerned reply information are registered; and
(E-2) measuring the elapsed time after the count value corresponding to the concerned reply information is finally updated in said management table, wherein
the reply packet about the reply information is generated when the elapsed time of the reply information that is measured in said (E-2) exceeds the prefixed value.

7. A data communication system comprising:
a data transmitting device; and
a data receiving device that is connected with said data transmitting device through a packet-switched network, wherein
said data transmitting device comprises:
a data packet generating means which generates a plurality of data packets according to a data transfer command;
a data packet transmitting means which sends said plurality of data packets to said data receiving device; and
a judging means which judges completion of data transmission from said data transmitting device to said data receiving device, and
said data receiving device comprises:
a reply information issuing means which issues a reply information at completion of each reception of a plurality of said data packet;
a reply information managing means which counts number of the reply information that is issued by said reply information issuing means and holds the count value;
a reply packet generating means which generates a reply packet including the count value about the reply information by receiving the concerned reply information from said reply information managing means; and
a reply packet transmitting means which sends the reply packet that is generated by said reply packet generating means to said data transmitting device, wherein
said judging means judges completion of data transmission from said data transmitting device to said data receiving device based on number of said plurality of data packets of which said data packet generating unit generates and the counts value that is included in the reply packet that is received from said data receiving device.
